(19) United States
(12) Patent Application Publication
(10) Pub. No.: US 2007/0089949 A1
(43) Pub. Date: Apr. 26, 2007

(54) Vibration damping rubber member and method of producing the same

(75) Inventors: Toyohisa Tohyama, Toyoake-shi (JP); Takanori Sugiura, Nagoya-shi (JP); Takehiko Taguchi, Nagoya-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOKAI RUBBER INDUSTRIES, LTD., Komaki-shi (JP)

(21) Appl. No.: 11/585,849

(22) Filed: Oct. 25, 2006

(30) Foreign Application Priority Data
Oct. 26, 2005 (JP) 2005-311418
Mar. 14, 2006 (JP) 2006-069556

(51) Int. Cl. F16F 9/50

(52) U.S. Cl. 188/281

(57) ABSTRACT

A vibration damping rubber member comprising a metallic structure and a rubber material, which are interposed by an undercoating adhesive layer formed on the metallic structure and a finish coating adhesive layer formed on the undercoating adhesive layer and are integrally formed via the adhesive layers, wherein the undercoating adhesive layer is formed by resorcinol adhesive (component (A)), the finish coating adhesive layer is formed by adhesive consisting mainly of chlorinated polyolefin (component (B)), and the rubber material is bonded onto the finish coating adhesive layer by vulcanization. A method of producing the vibration damping rubber member is also disclosed.

### BACKGROUND OF THE INVENTION

1. Field of the Invention

The present invention relates to a vibration damping rubber member that can widely be utilized for an automotive bushing, an automotive engine mount and a vibration damping member in industrial machinery and the like, and a method of producing the vibration damping rubber member.

2. Description of the Art

Generally, a vibration damping rubber member that can widely be utilized for an automotive bushing, an automotive engine mount and a vibration damping member in industrial machinery and the like, is a rubber material with a metallic structure formed integrally therebetween, and is used for connecting various components, such as a frame and an engine.

Conventionally, adhesive is used for bonding the interface between the rubber material and the metallic structure in the above-mentioned vibration damping rubber member. Exemplary methods for bonding the interface therebetween include “one-step application method” wherein one adhesive is used and “two-step application method” wherein undercoating adhesive is applied to a surface of the metallic structure as primer and then finish coating adhesive is further applied thereto. The two-step application method has been widely used for bonding general-purpose rubber and metallic structure (see, for example, Japanese Unexamined Patent Publication Nos. 7-301278 and 2001-170944).

Further, the above-mentioned vibration damping rubber member may be produced, for example, by installing the metallic structure provided with the above-mentioned adhesive in a mold for forming a vibration damping rubber member and casting a rubber composition (unvulcanized rubber) into the mold by means of injection molding or the like (see, for example, Japanese Unexamined Patent Publication Nos. 2002-227897 and 2003-148536).

Naturally, parts used in a high-temperature environment, such as an automotive bushing and an automotive engine mount, require heat resistance (or heat-resistant adhesion on an interface between a rubber material and a metallic structure). In a vibration damping rubber member having the structure that the rubber material is formed into a chamber wall to be deformed according to a vibrational input and liquid (such as ethylene glycol) is filled into an enclosed space defined by the chamber wall and a part of the metallic structure, as described in Japanese Unexamined Patent Publication No. 7-301278, the filling liquid easily penetrates an adhesive interface between the rubber material and the metallic structure, which may deteriorate adhesive force. Thus, improvement of adhesion remains an outstanding issue especially for the vibration damping rubber member having such a structure.

However, it is confirmed that interfacial peeling occurs in the conventional vibration damping rubber member under durability use in a high-temperature environment (especially in an environment where ethylene glycol may penetrate an adhesive interface). Thus, there are few products provided with desired durability performance (having stable initial adhesion under ethylene glycol immersion at 100 to 120° C. over 500 hours) at the present time. Further, even such products provided with the desired durability have other various problems. For example, undercoating adhesive (CHEMLOK 901 available from Lord Corporation) including resorcin hexamine resin as a main component and selenium as a catalyst is used for the metallic structure of a vibration damping rubber member described as an example in Japanese Unexamined Patent Publication No. 7-301278. Thereby, a heat-resistant adhesion issue is solved to some extent. However, since selenium is a substance having highly toxic consequences on the environment, there is high demand that strong adhesion can be obtained without use of selenium from the viewpoint of environmental issue.

Further, there are some conventional vibration damping rubber members, which solve the heat-resistant adhesion issue in a sort, but have another problem that adhesive is transferred to a mold with heat for molding, which may deteriorate mass-productivity. In detail, in the case where conventional adhesive is applied to the interface between the rubber material and the metallic structure for producing the above-mentioned vibration damping rubber member, fundamental performance including initial adhesion is satisfactory. However, the adhesive softens with heat in a rubber vulcanization process after application of the adhesive, and thereafter thus softened adhesive is transferred to a mold and cured, which may deteriorate mold smear.

Especially, in a method by using a mold having a cavity where a rim of the cavity (opening) is pressed onto an adhesive surface provided on the metallic structure and rubber composition is injected into a molding space defined by such an adhesive surface and the cavity, the mold should be pressed onto the adhesive surface until the mold bites into the adhesive surface to control occurrence of burr. For this reason, a joint area where the adhesive surface and the mold contact each other comes into a state that both surfaces coalesce tentatively. If the mold is removed in such a state where the adhesive surface is coalesced onto the mold, a portion of the adhesive surface on the joint area is peeled off compellingly. As a result, cohesive failure occurs. Therefore, maintenance frequency is increased by mold smear in such a method, which remarkably deteriorates mass-productivity of the vibration damping rubber member and significantly exerts negative impacts on the quality of the vibration damping rubber member.

### SUMMARY OF THE INVENTION

The present invention has been made in view of the above circumstances. Accordingly, an object of the invention is to provide a vibration damping rubber member, excluding environmental load material, that has excellent heat-resistant adhesion on an interface between a rubber material and a metallic structure and resistance against ethylene glycol immersion on the interface therebetween, and is to provide a method of producing the vibration damping rubber member excellent in quality whereby mold smear is suppressed, molding processability and mass-productivity are excellent.

To achieve the above object, the vibration damping rubber member according to the first gist of the invention includes a metallic structure and a rubber material, which are interposed by an undercoating adhesive layer formed on the metallic structure and a finish coating adhesive layer formed on the undercoating adhesive layer and are integrally formed via the adhesive layers, wherein the undercoating adhesive layer is formed by resorcinol adhesive (component (A)), the finish coating adhesive layer is formed by adhesive consisting mainly of chlorinated polyolefin (component (B)), and the rubber material is bonded onto the finish coating adhesive layer by vulcanization.

To overcome the above-mentioned problems, the inventors have piled up investigations. During such investigations, they found out that heat-resistant adhesion as excellent as a conventional product including selenium can be obtained by using resorcinol adhesive (excluding highly toxic substance of selenium) as undercoating adhesive applied to a surface of the metallic structure. Further, the inventors found out that adhesion higher than the conventional product can be obtained by such a product in view of resistance against ethylene glycol. Finally, they found out that excellent adhesive property can be obtained between the metallic structure and the rubber material by vulcanizing a rubber composition via a layer formed by the undercoating adhesive and a finish coating adhesive layer formed thereon by using adhesive consisting mainly of chlorinated polyolefin and, especially, excluding chlorinated natural rubber so as to be bonded therebetween. Thus, the invention has been accomplished based on these findings.

To achieve the above object, a method of producing the vibration damping rubber member of a metallic structure and a rubber material integrally formed therebetween via two adhesive layers by press molding according to the second gist of the invention includes the steps of forming an undercoating adhesive layer by resorcinol adhesive (component (A)) on an interface of the metallic structure, forming a finish coating adhesive layer on a surface of the undercoating adhesive layer by chlorosulfonated polyethylene (CSM) adhesive excluding a tackifier (component (B′)), preparing a mold assembly having a cavity, pressing a rim of the cavity onto a surface of the metallic structure via the two adhesive layers, injecting a rubber composition into a molding space defined with the surface of the two adhesive layers and the cavity, vulcanizing the rubber composition, and removing the metallic structure provided with the rubber material formed by vulcanization simultaneously when releasing the press.

The present inventors also found out that excellent heat-resistant adhesion can be obtained by using resorcinol adhesive as undercoating adhesive applied to a surface of the metallic structure in the above-mentioned method wherein rubber composition is injected into the molding space defined by the surface of the two adhesive layers and the cavity and then the rubber composition is vulcanized. Further, the inventors found out that excellent adhesive property can be obtained between the metallic structure and the rubber material by forming a finish coating adhesive layer using chlorosulfonated polyethylene (CSM) on a surface of the undercoating adhesive layer and bonding the rubber material to the metallic structure through this finish coating adhesive layer by means of vulcanization, Still further, they found out that almost no bad effects will be exerted on such bonding by means of vulcanization, according to the present invention (the second gist), by excluding a tackifier (such as rosin, rosin derivative, polyterpene resin, terpene phenol resin and petroleum resin), which is conventionally blended into the above-mentioned finish coating adhesive. Even still further, they found out that adhesion on a joint area where the adhesive surface and the mold contact can be reduced in pressing the adhesive layers onto the mold, as described above, by excluding such a tackifier, so that cohesive failure does not occur in the adhesive layers when the mold is removed, and as a result, mold smear can be suppressed and thus high quality vibration damping rubber member can be produced with excellent mold processability and high mass-productivity.

The vibration damping rubber member of the present invention employs the resorcinol adhesive as the undercoating adhesive layer and the adhesive consisting mainly of chlorinated polyolefin as the finish coating adhesive layer. For this reason, the vibration damping rubber member of the present invention is superior from the viewpoint of environmental issue because environmental load substance of selenium is not required, and also has excellent heat-resistant adhesion and resistance against ethylene glycol. Therefore, the vibration damping rubber member formed by bonding the metallic structure and the rubber member integrally via such adhesive layers is suitable for use under high temperature environment, for example, as an automotive bushing and an automotive engine mount. Especially, when the vibration damping rubber member is filled with liquid such as ethylene glycol, such vibration damping rubber member can exert durability superior to the conventional type thereof.

When the undercoating adhesive contains butadiene resin, hexamethylenetetramine and resorcinol as a resin component, even if resorcinol is reduced by a specified rate, desired heat-resistant adhesive can be obtained. The use of resorcinol and also hexamethylenetetramine as its curing agent alleviates the problem that the adhesive is transferred to a mold with heat for molding, which deteriorates product quality.

When the undercoating adhesive contains metal oxide (such as zinc oxide and titanium oxide) at a specific rate in addition to the above-mentioned indispensable components, the vibration damping rubber member of the present invention comes to have more excellent heat resistance.

When the finish coating adhesive excludes chlorinated natural rubber, resistance against ethylene glycol on the interface between the metallic structure and the rubber material becomes more excellent.

In the meantime, the method of producing the vibration damping rubber member of a metallic structure and a rubber material integrally formed therebetween via two adhesive layers by press molding, according to the present invention, comprises the steps of forming an undercoating adhesive layer by resorcinol adhesive on an interface of the metallic structure, forming a finish coating adhesive layer on a surface of the undercoating adhesive layer by chlorosulfonated polyethylene (CSM) adhesive excluding a tackifier (such as rosin, rosin derivative, polyterpene resin, terpene phenol resin and petroleum resin), preparing a mold assembly having a cavity, pressing a rim of the cavity onto a surface of the metallic structure via the two adhesive layers, injecting a rubber composition into a molding space defined with the surface of the two adhesive layers and the cavity, vulcanizing the rubber composition, and removing the metallic structure provided with the rubber material formed by vulcanization simultaneously when releasing the press. Thereby, cohesive failure does not occur in the adhesive layers when the mold is removed and thus the mold and the adhesive layers can be separated, and as a result, mold smear can be suppressed and thus high quality vibration damping rubber member can be produced with excellent mold processability and high mass-productivity. Also, maintenance frequency is reduced by suppressing mold smear.

Especially, when the finish coating adhesive excludes chlorinated polyethylene and chlorinated natural rubber in the above-mentioned method, more excellent adhesive property can be obtained between the metallic structure and the rubber material.

The vibration damping rubber member obtained by the above-mentioned method has high adhesive property on the interface between the metallic structure and the rubber material and is free from cohesive failure and burr in the adhesive layers and thus has high quality.

### BRIEF DESCRIPTION OF THE DRAWING

FIG. 1 is a sectional view showing a cylindrical bushing as one embodiment of the vibration damping rubber member according to the invention;

FIG. 2 is a partially sectional enlarged view showing the cylindrical bushing;

FIG. 3 is a partially sectional enlarged view showing the cylindrical bushing;

FIG. 4 is a front view showing a specimen employed for a filling-liquid resistance test and a peeling test;

FIG. 5 is an explanatory view showing one example of a process of producing a vibration damping rubber member according to the invention;

FIG. 6 is an exploded perspective view showing a mold assembly employed for producing the vibration damping rubber member;

FIG. 7 is a sectional view showing one example of the vibration damping rubber member; and

FIG. 8 is a partially sectional enlarged view showing the vibration damping rubber member.

### DETAILED DESCRIPTION OF THE INVENTION

The present invention is described in detail below.

FIG. 1 shows one embodiment of the vibration damping rubber member according to the invention. In this embodiment, an automotive cylindrical bushing is explained as one example of the vibration damping rubber member. The cylindrical bushing is a structure that an inner sleeve member (metallic structure) 2 is coaxially integrally formed on an inner peripheral surface of a cylindrical vibration damping rubber (rubber material) 1 and an outer sleeve member (metallic structure) 3 is coaxially integrally formed on an outer peripheral surface of the cylindrical vibration damping rubber 1.

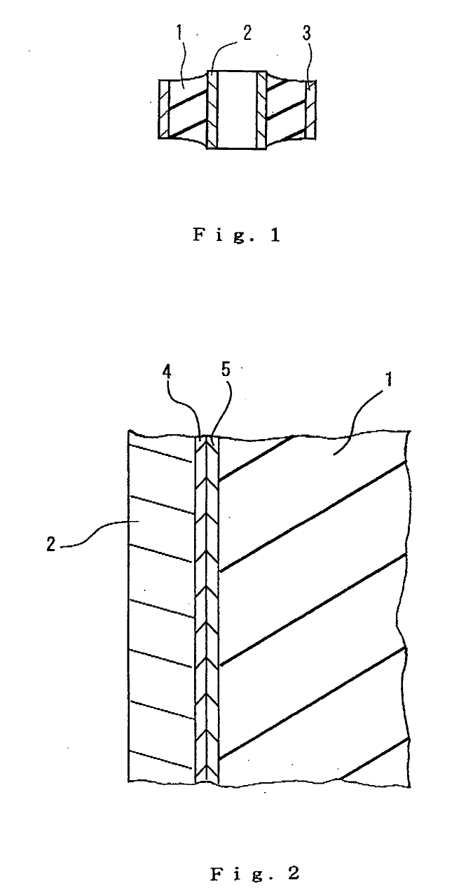

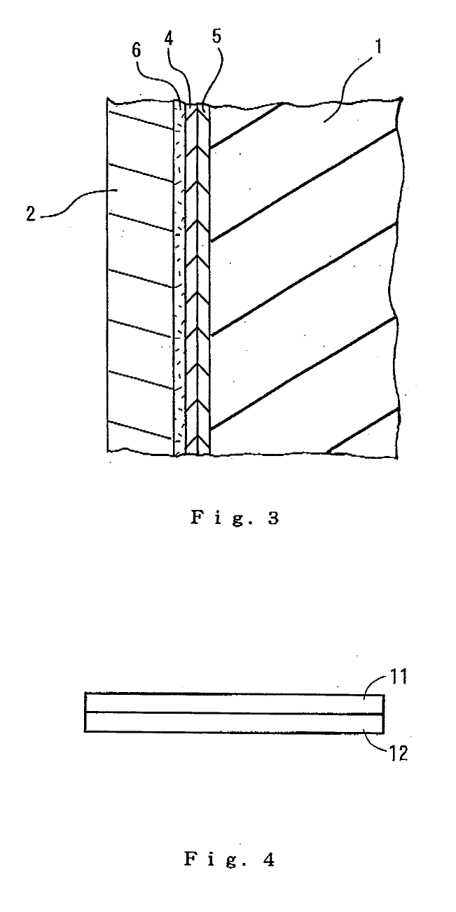

On an interface between the inner sleeve member 2 and the cylindrical vibration damping rubber 1, as shown in FIG. 2, an enlarged view thereof, an undercoating adhesive layer 4 is formed on an outer peripheral surface of the inner sleeve member 2, a finish coating adhesive layer 5 is formed on an outer peripheral surface of the undercoating adhesive layer 4 and the vibration damping rubber 1 is formed on an outer peripheral surface of the finish coating adhesive layer 5. The undercoating adhesive layer 4 is formed by resorcinol adhesive (excluding selenium), the finish coating adhesive layer 5 is formed by adhesive consisting mainly of chlorinated polyolefin, and the vibration damping rubber 1 is bonded to the finish coating adhesive layer 5 by vulcanization, which is the most characteristic feature of the present invention. The expression “consisting mainly of” used for the finish coating adhesive herein means an element having a significant effect on characteristic properties of the adhesive and occupying 50% or more of the entire resinous solid content. Further, if the surface of the metallic structure corrodes, adhesion between the metallic structure and the rubber material deteriorates, so that the resulting vibration damping rubber member may not fulfill its function. Therefore, a chemical film (such as zinc phosphate film) 6 may be formed on an outer peripheral surface of the inner sleeve member 2 as an anticorrosive measure, as required, as shown in FIG. 3, and then the undercoating adhesive layer 4 and the finish coating adhesive layer 5 are formed successively. Further, each of the above-mentioned layers and film is formed similarly between the outer sleeve member 3 and the vibration damping rubber 1.

Now, materials for forming the vibration damping rubber member are explained in detail.

A material for forming the vibration damping rubber 1 is not particularly limited and examples thereof include, for example, a natural rubber (NR), a butadiene rubber (BR), a styrene-butadiene rubber (SBR), an isoprene rubber (IR), acrylonitrile-butadiene rubber (NBR), carboxyl modified NBR, a chloroprene rubber (CR), an ethylene-propylene rubber (EPM, EPDM), maleic acid modified EPM, butyl rubber (IIR), halogenated IIR, chlorosulfonated polyethylene (CSM), fluororubber (FKM), acrylic rubber and epichlorohydrin rubber, which may be used either solely or in combination thereof. Among them, natural rubber is preferably used in terms of good vibration damping property. In addition to the rubber, various additives such as a reinforcing agent (such as carbon black), a vulcanizing agent, vulcanization accelerator, lubricant, an auxiliary agent, a plasticizer and an antioxidant may be appropriately added.

The inner sleeve member 2 and the outer sleeve member 3 are not particularly limited so long as those are made of a metal. For example, the conventional metals such as iron, copper, aluminum, magnesium, zinc, tin or their alloys, and stainless steel are used. The inner sleeve member 2 and the outer sleeve member 3 may be formed by the same metal or by different metals from each other.

As mentioned above, the undercoating adhesive layer 4 is formed by the resorcinol adhesive (excluding selenium). The material is free from selenium, which is excellent from the viewpoint of an environmental issue. Further, even if the material is free from selenium, excellent heat-resistant adhesion can be obtained. Preferably used is such undercoating adhesive that contains butadiene resin, hexamethylenetetramine and resorcinol as a resin component and contains the resorcinol at a rate of 1 to 25 parts by weight (just abbreviated to “parts” hereinafter) based on 100 parts of the adhesive solid content. The use of resorcinol and also hexamethylenetetramine as its curing agent alleviates the problem that the adhesive is transferred to a mold with heat for molding, which reduces deterioration of the product quality and mass-productivity. Further, even if resorcinol is reduced as mentioned above, desired heat-resistant adhesive can be obtained.

When the undercoating adhesive contains zinc oxide and titanium oxide at 20 to 50 parts, respectively, based on 100 parts of the adhesive solid content in addition to the resin component, the vibration damping rubber member of the present invention comes to have more excellent heat resistance, which is preferred. Further, various additives such as carbon black, a crosslinking agent and filler may be added to the undercoating adhesive, as required, and xylene, ethyl benzene, methyl isobutyl ketone or the like may be used as solvent for the adhesive.

Examples of the undercoating adhesive free from selenium available in the market include, for example, XPJ-113, XPJ-77 and XPJ-106 available from Lord Far East Incorporated, which may be used either solely or in combination thereof.

Further, selenium (Se) of the undercoating adhesive layer 4 can be detected, for example, by an electron probe microanalyzer (EPMA-1600 available from Shimadzu Corporation). In detail, such detection is conducted by testing the presence of selenium (Se) with a wavelength of 8. 9900Å (angstrom) under the following conditions.

Accelerating voltage: 15 KV

Beam size: 1 μm

Beam current: 0.1041 μA

Specimen current: 0.0755 μA

Analyzing crystal: RAP (rubidium acid phthalate)

As mentioned above, the finish coating adhesive layer 5 is formed by adhesive consisting mainly of chlorinated polyolefin. The chlorinated polyolefin is not particularly limited, however, chlorosulfonated polyethylene (CSM) and chlorinated polyethylene are preferred in its excellent adhesive property, and they may be used either solely or in combination thereof. Further, it is preferred that chlorinated natural rubber is not included in the adhesive in the present invention because resistance against ethylene glycol on the interface between the metallic structure and the rubber material becomes more excellent. Still further, various additives such as filler (such as silica), zinc compound, carbon tetrachloride, pigment and a crosslinking agent may be added to the finish coating adhesive, appropriately, as required, and xylene, triol or the like may be used as a solvent for the adhesive.

Examples of the finish coating adhesive available in the market include, for example, XJ-370, XJ-371, XJ-380 and XJ381 available from Lord Far East Incorporated, which are excellent from the viewpoint of heat-resistant adhesion. Among them, XJ-370 is more preferred because it excludes chlorinated natural rubber and has excellent resistance against ethylene glycol. Further, they may be used either solely or in combination thereof.

As mentioned above, the chemical film 6 shown in FIG. 3 may be formed, as required. As solution for forming the chemical film 6, for example, when forming a zinc phosphate film, employed is an aqueous solution including zinc phosphate and oxidant such as nitrite salt and having pH 2 to 3. The concentration of zinc phosphate in the aqueous solution is typically 10 to 20% by weight. Further, the chemical film is not limited to the zinc phosphate film and may be formed by, for example, zinc phosphate calcium, manganese phosphate, iron phosphate, tin phosphate and the like.

The above-mentioned cylindrical bushing may be produced, for example, as follows. However, the method of producing the vibration damping rubber member is not particularly limited to the following process.

First, an inner sleeve member (metallic structure) 2 and an outer sleeve member (metallic structure) 3 are prepared. An outer peripheral surface of the inner sleeve member 2 and an inner peripheral surface of the outer sleeve member 3 are roughened, appropriately. Specifically, an inner peripheral surface of the inner sleeve member 2 and its both opening distal ends, an outer peripheral surface of the outer sleeve member 3, and its both opening distal ends are masked, and then the outer peripheral surface of the inner sleeve member 2 and the inner peripheral surface of the outer sleeve member 3 are roughened by sandblasting by means of an abrading agent having a particle size of about #20 to #70 so as to have a surface roughness of about 10 to 30 μm in terms of ten-point mean roughness (Rz) by using a surface roughness measuring device (SURFCOM 1400D available from TOKYO SEIMITSU CO. LTD.). Then, an adhesive layer is formed on the roughened surface, however, prior to formation of the adhesive layer, a chemical film 6 (having a film weight of about 1.5 g/m² to 4.0 g/m²) may be formed by zinc phosphate liquid or the like, as required. The thus treated outer peripheral surface of the inner sleeve member 2 and the thus treated inner peripheral surface of the outer sleeve member 3 are coated with an undercoating adhesive by spraying or the like, and thereafter are dried naturally (at 25° C. (room temperature) for about 60 minutes) for forming an undercoating adhesive layer 4 (having a thickness of about 5 to 20 μm). Successively, a surface of the undercoating adhesive layer 4 is coated with a finish coating adhesive by spraying or the like, and thereafter is dried naturally (at 25° C. (room temperature) for about 60 minutes) for forming a finish coating adhesive layer 5 (having a thickness of about 5 to 20 μm). After removing the above-mentioned masking from the inner sleeve member 2 and the outer sleeve member 3, the resulting inner sleeve member 2 and the resulting outer sleeve member 3 are coaxially installed in a mold, and unvulcanized rubber for forming the vibration damping rubber 1 is filled into the molding space defined by the inner sleeve member 2 and the outer sleeve member 3 and is vulcanized (at 140 to 200° C. for about 5 to 60 minutes). Thus, the above-mentioned cylindrical bushing can be produced.

The vibration damping rubber member of the present invention is used not only as the above-mentioned cylindrical rubber bushing but also preferably as other vibration damping materials, such as a bushing, an engine mount, a motor mount or the like and having a shape other than a cylinder, used in an automotive vehicle or a transport machine (an airplane, industrial machinery such as a forklift, a tractor shovel and a crane, and a railroad vehicle) In other words, the shape of the metallic structure is not limited to a cylinder, and may have various shapes such as a plate or a bellows. In such a case, generally, a sandwich shape is employed wherein a rubber material is sandwiched between an upper metallic structure and a lower metallic structure, however, either of an upper metallic structure or a lower metallic structure may be provided.

The vibration damping rubber member of the present invention may have a liquid-sealed type, as described in Japanese Patent Unexamined Patent Publication No. 7-301278, and may have the construction that the rubber material is formed into a chamber wall so as to be deformed according to the vibrational input and liquid is filled into an enclosed space defined by the chamber wall and a part of the metallic structure. According to the present invention, the metallic structure and the rubber material are bonded through the specific undercoating layer formed on the metallic structure and the specific finish coating layer formed on the undercoating layer. Further, as the liquid sealed therein, conventionally used liquid such as ethylene glycol, diethylene glycol, water or the like is used. As described above, the interface between the metallic structure and the rubber material of the vibration damping rubber member can exert excellent heat resistance compared with the conventional vibration damping rubber material employing ethylene glycol as a sealing liquid.

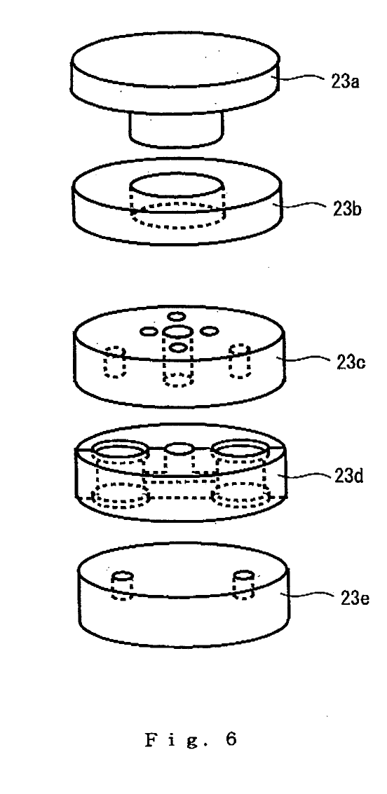

In the meantime, the other method (according to the second gist of the present invention) of producing the vibration damping rubber member of the present invention is described in detail with reference to FIGS. 5 to 8.

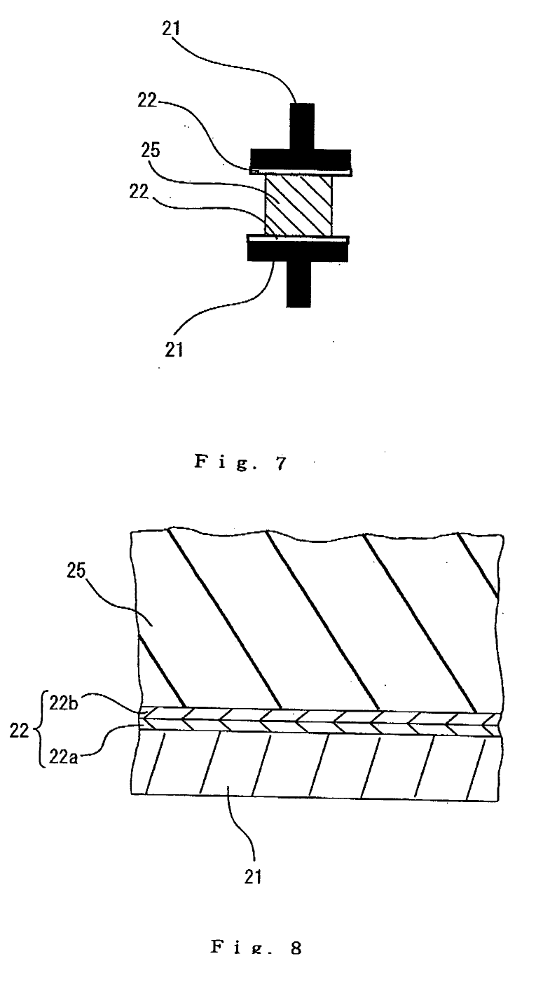

FIG. 5 is an explanatory view showing one embodiment of a process of producing a vibration damping rubber member according to the invention and FIG. 6 is an exploded perspective view showing a mold assembly employed in the embodiment of FIG. 5. In this embodiment, metallic structures 21 onto which each specific adhesive layer 22 is formed are installed in the mold assembly 23 composed of mold components 23a, 23b, 23c, 23d and 23e such that each rim 23A of a cavity defined by an inner peripheral surface of the mold component 23d and the like is brought in contact with a surface of each adhesive layer 22 formed on the metallic structures 21. Then, the mold assembly 23 is strongly pressed (in each direction of arrows shown in FIG. 5) until the rim 23A of the mold component 23d bites into the adhesive layer 22 and in such a state rubber composition is injected into the molding space 24 defined by the metallic structures 21 each provided with the adhesive layer 22 and the mold assembly 23. Occurrence of burr can be suppressed even if the rubber composition is injected by increasing the press on the mold assembly 23, as mentioned above. Successively, the rubber composition thus injected into the molding space 24 is heated for vulcanization (at 140 to 200° C. for about 5 to 60 minutes), and the resulting rubber material (vibration damping rubber) obtained by the above-mentioned vulcanization is removed with simultaneously releasing the press of the mold assembly 23. Since the mold component 23d is a split mold, the rubber material can be removed by halving the mold component 23d. Thus, the vibration damping rubber member wherein the metallic structures 21 and the vibration damping rubber 25 are integrally formed via the adhesive layer 22, as shown in FIG. 7, can be produced.

An interface between the metallic structure 21 and the vibration damping rubber 25 is magnified—as shown in FIG. 8. According to the present invention, the above-mentioned adhesive layer 22 has a laminate structure composed of an undercoating adhesive layer 22a formed on an interface of the metallic structure 21 and a finish coating layer 22b formed on the undercoating adhesive layer 22a. The undercoating adhesive layer 22a formed on the surface of the metallic structure 21 is formed by resorcinol adhesive and the finish coat adhesive layer 22b is formed by chlorosulfonated polyethylene (CSM) adhesive excluding a tackifier, and then the vibration damping rubber 25 is bonded to the finish coating adhesive 22b by means of vulcanization. Since the adhesive layer 22 has such a structure, excellent heat-resistant adhesion between the metallic structure 21 and the vibration damping rubber 25 can be obtained and also adhesion can be decreased on an area 22A where the rim 23A of the mold component 23d contacts the adhesive layer 22, so that the mold can be removed without cohesive failure in the adhesive layer in such a removal procedure, and as a result, mold smear can be suppressed and thus high quality vibration damping rubber member can be produced with excellent mold processability and high mass-productivity. Further, the undercoating adhesive layer 22a and the finish coating adhesive layer 22b (each having a thickness of about 5 to 20 μm) are each formed by application with spraying or the like, and thereafter are dried naturally (at 25° C. (room temperature) for about 60 minutes).

The materials for forming the vibration damping rubber member produced by the above-mentioned method (second gist of the present invention) are described in detail below.

The rubber composition for forming the vibration damping rubber 25 is not particularly limited as long as it can be injected. Examples thereof include, for example, a natural rubber (NR), a butadiene rubber (BR), a styrene-butadiene rubber (SIBR), an isoprene rubber (IR), acrylonitrile-butadiene rubber (NBR), carboxyl modified NBR, a chloroprene rubber (CR), an ethylene-propylene rubber (EPM, EPDM), maleic acid modified EPM, butyl rubber (IIR), halogenated IIR, fluororubber (FKM), acrylic rubber or epichlorohydrin rubber, which may be used either solely or in combination thereof. Among them, natural rubber is preferably used in terms of good vibration damping property. Further, various additives such as a reinforcing agent (such as carbon black), a vulcanizing agent, vulcanization accelerator, lubricant, an auxiliary agent, a plasticizer and an antioxidant may be appropriately added to the rubber composition.

The metallic structure 21 is not particularly limited so long as it is made of a metal. For example, the conventional metals such as iron, copper, aluminum, magnesium, zinc, tin or their alloys, and stainless steel are used.

As mentioned above, the undercoating adhesive layer 22a is formed by the resorcinol adhesive. The resorcinol adhesive is not particularly limited, however, preferably used is such undercoating adhesive that contains butadiene resin, hexamethylenetetramine and resorcinol as a resin component and contains the resorcinol at a rate of 1 to 25 parts by weight (just abbreviated to “parts” hereinafter) based on 100 parts of the adhesive solid content. The use of resorcinol and also hexamethylenetetramine as its curing agent alleviates the problem can be overcome that the adhesive is transferred to a mold with heat for molding, which deteriorates product quality and mass-productivity. Further, even if resorcinol is reduced as mentioned above, desired heat-resistant adhesive can be obtained.

When the resorcinol adhesive contains metallic oxide, such as zinc oxide and titanium oxide, at 20 to 50 parts based on 100 parts of the adhesive solid content in addition to the resin component, the resultant vibration damping rubber member comes to have more excellent heat resistance, which is preferred. Further, various additives such as carbon black, a crosslinking agent and filler may be added to the resorcinol adhesive, as required, and xylene, ethyl benzene, methyl isobutyl ketone or the like may be used as solvent for the adhesive.

Examples of the resorcinol adhesive available in the market include, for example, XPJ-113, XPJ-77 and XPJ-106 available from Lord Far East Incorporated, which may be used either solely or in combination thereof.

The finish coating adhesive layer 22b is formed, as described above, by chlorosulfonated polyethylene (CSM) adhesive excluding a tackifier. The above-mentioned tackifier herein means rosin, rosin derivative, polyterpene resin, terpene phenol resin, petroleum resin and the like. Further, various additives such as filler, such as silica, zinc compound, carbon tetrachloride, pigment, a crosslinking agent may be added to the finish coating adhesive, appropriately, as required, and xylene, triol or the like may be used as a solvent for the adhesive. Still further, when the above-mentioned CSM adhesive excludes chlorinated polyethylene and chlorinated natural rubber, more excellent adhesive property can be obtained between the metallic structure 21 and the vibration damping rubber 25, which is preferred.

Examples of the CSM adhesive excluding a tackifier available in the market include, for example, XJ-405 available from Lord Far East Incorporated and the like, which may be used either solely or in combination thereof.

The vibration damping rubber member produced by the above-mentioned method (second gist of the present invention) can be obtained in accordance with the above-mentioned procedure (see FIG. 5) by using the above-mentioned materials. In the above-mentioned procedure, the surface of the metallic structure 21 on which the undercoating adhesive layer 22a is formed may appropriately be roughened. Specifically, portions not to be roughened are masked, and then the surface other than such portions are roughened by sandblasting by means of an abrading agent having a particle size of about #20 to #70 so as to have a surface roughness of about 10 to 30 μm in terms of ten-point mean roughness (Rz) by using a surface roughness measuring device (SURFCOM 1400D available from TOKYO SEIMITSU CO. LTD.).

Further, if the metallic structure 21 corrodes, adhesion on an interface with the undercoating adhesive layer 22a is deteriorated and the resulting vibration damping rubber member may not fulfill its function. Therefore, as a measure to prevent corrosion, a chemical film (having a film weight of about 1. 5 g/m² to4.0 g/m²) may be formed by zinc phosphate liquid or the like, as required, on the surface of the metallic structure 21, and then the undercoating adhesive layer 22a and the finish coating layer 22b may be formed over the chemical film, successively.

As solution for forming the chemical film, for example, when forming a zinc phosphate film, employed is an aqueous solution including zinc phosphate and oxidant such as nitrite and having pH 2 to 3. The concentration of zinc phosphate in the aqueous solution is typically 10 to 20% by weight. Further, the chemical film is not limited to the zinc phosphate film and may be formed by, for example, zinc phosphate calcium, manganese phosphate, iron phosphate, tin phosphate and the like.

The vibration damping rubber member produced by the above-mentioned method (second gist of the present invention) is not particularly limited as long as it is obtained by the above-mentioned method. Therefore, the shape is not limited to that as shown in FIG. 7. Various kinds of vibration damping rubber members can be produced by changing the shape of the mold assembly 23 or that of the metallic structure 21. Specifically, the shape of the metallic structure 21 having various shapes such as a cylinder, a plate or a bellows can be used. Further, the vibration damping rubber member, generally, employs a sandwich shape wherein a rubber material is sandwiched between an upper metallic structure and a lower metallic structure (as shown in FIG. 7), however, may employ a shape wherein a rubber material is attached to one metallic structure. Even such a vibration damping rubber member may be used preferably as other vibration damping materials, such as a bushing, an engine mount, a motor mount or the like and having a shape other than a cylinder, used in an automotive vehicle or a transport machine (an airplane, industrial machinery such as a forklift, a tractor shovel and a crane, and a railroad vehicle).

The present invention is described in more detail by reference to the following Example and Comparative Example. However, the present invention is not limited to these Examples.

### EXAMPLES 1 to 3 AND COMPARATIVE EXAMPLE 1

In order to validate the performance of the vibration damping rubber member according to the present invention, first of all, undercoating adhesive, finish coating adhesive and unvulcanized rubber were prepared as follows.

Undercoating Adhesive (i)

The undercoating adhesive (i) was prepared by mixing 20% by weight (just abbreviated to %, hereinafter) of xylene, 4.6% of ethyl benzene, 1.9% of hexamethylenetetramine, 2% of resorcinol, 56% of methyl isobutyl ketone, 1.5% of carbon black, 6% of zinc oxide, 5% of titanium oxide and 3% of butadiene resin.

Undercoating Adhesive (ii)

CHEMLOK 901 available from Lord Corporation

Finish Coating Adhesive (i)

CSM adhesive (C6100 available from Lord Corporation)

Finish Coating Adhesive (ii)

Chlorinated polyethylene adhesive (XJ370 available from Lord Corporation)

Unvulcanized Rubber (i)

Unvulcanized rubber was prepared by kneading 100 parts of natural rubber, 35 parts of HAF (High Abrasion Furnace) carbon black (SEAST 3 available from Tokai Carbon Co., Ltd.), 5 parts of zinc oxide (one kind of zinc oxide available from Sakai Chemical Industry Co., Ltd.), 2 parts of stearic acid (LUNAC S-30 available from Kao Corporation), 0.7 parts of vulcanization accelerator (SOXINOL CZ available from Sumitomo Chemical Co., Ltd.) and 2 parts of sulfur (SULFAX200S available from Tsurumi Kagaku Kogyo Kabushikikaisha) by means of a kneader and a mixing mill.

Unvulcanized Rubber (ii)

Unvulcanized rubber was prepared by kneading 70 parts of natural rubber, 30 parts of SBR, 35 parts of HAF (High Abrasion Furnace) carbon black (SEAST 3 available from Tokai Carbon Co., Ltd.), 5 parts of zinc oxide (one kind of zinc oxide available from Sakai Chemical Industry Co., Ltd.), 2 parts of stearic acid (LUNAC S-30 available from Kao Corporation), 0.7 parts of vulcanization accelerator (SOXINOL CZ available from Sumitomo Chemical Co. , Ltd.) and 2 parts of sulfur (SULFAX 200S available from Tsurumi Kagaku Kogyo Kabushikikaisha) by means of a kneader and a mixing mill.

Unvulcanized Rubber (iii)

Unvulcanized rubber was prepared by kneading 100 parts of IIR, 35 parts of HAF (High Abrasion Furnace) carbon black (SEAST 3 available from Tokai Carbon Co.,.Ltd.), 5 parts of zinc oxide (one kind of zinc oxide available from Sakai Chemical Industry Co., Ltd.), 2 parts of stearic acid (LUNAC S-30 available from Kao Corporation), 0.7 parts of vulcanization accelerator (SOXINOL CZ available from Sumitomo Chemical Co., Ltd.) and 2 parts of sulfur (SULFAX 200S available from Tsurumi Kagaku Kogyo Kabushikikaisha) by means of a kneader and a mixing mill.

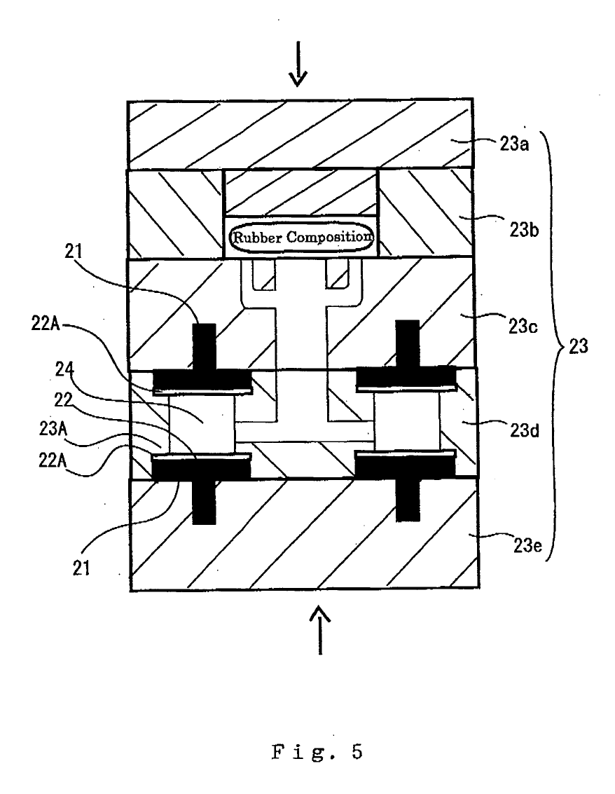

Each specimen (for evaluating the interface between the metallic structure and the rubber material), as shown in FIG. 4, was produced by employing the thus prepared materials. This specimen was produced by integrally forming a rectangular rubber plate 11 (25 mm×60 mm×1.5 mm (thickness)) onto one entire surface of a rectangular metallic plate 12 (25 mm×60 mm×2 mm (thickness)) made of SUS304 stainless steel.

First of all, in producing the above-mentioned specimen, one surface of the stainless steel plate 12 was entirely roughened by sandblasting for one minute by means of an abrading agent made of alumina and having a particle size of #20 so as to have a surface roughness of about 10.0 μm in terms of ten-point mean roughness (Rz) by using a surface roughness measuring device (SURFCOM 1400D available from TOKYO SEIMITSU Co. LTD.). Then, each undercoating adhesive, as shown in the following Table 1, was coated on the entirely roughened surface of the stainless steel plate 12 by spraying (if difficult, by brushing). Thereafter, the thus treated surface was dried (at 25° C. for 60 minutes) for forming the undercoating adhesive layer (10 μm in thickness). Successively, each finish coating adhesive, as shown in the following Table 1, was coated on the surface of the undercoating adhesive by spraying, and thereafter, was dried (at 25° C. for 60 minutes) for forming the finish coating adhesive layer (10 μm in thickness). Then, unvulcanized rubber is filled into the cavity of the mold provided onto the thus treated surface of the stainless steel plate 12 and vulcanized (at 150° C. for 20 minutes). Thus, the specimen as shown in FIG. 4 was produced. Further, each thickness of the undercoating adhesive layer and the finish coating adhesive layer was the average value of randomly sampled 10 points by observing a section of cut specimen by means of an electron microscope.

Using each specimen thus obtained in the Examples and the Comparative Example, the characteristics thereof were evaluated according to the following criteria. The results obtained are also shown in the Table below.

Toxicity

Selenium (Se) of the adhesive layer was detected by an electron probe microanalyzer (EPMA-1600 available from Shimadzu Corporation). In detail, such detection was conducted by testing the presence of selenium (Se) with a wavelength of 8.9900 Å (angstrom) under the following conditions. When selenium (Se) was detected, the specimen was evaluated as “toxic”, while when it was not detected, the specimen was “non-toxic”.

Accelerating voltage: 15 KV

Beam size: 1 μm

Beam current: 0.1041 μA

Specimen current: 0.0755 μA

Analyzing crystal: RAP (rubidium acid phthalate)

Filling-liquid Resistance

Each specimen was soaked into ethylene glycol solution at a high temperature (100° C. or 120° C.) for 500 hours. Thereafter, the specimen was taken out of the ethylene glycol solution and was subject to a 90-degree peeling test. Each specimen was cut into a 10 mm-wide strips, and then the stainless steel plate 12, the vulcanized adhesive layer and the vibration rubber plate 11 at the distal end of the strip were peeled off from one another. Each distal end of the thus peeled-off stainless steel plate 12 and the thus peeled-off vibration rubber plate 11 was pinched by each chuck of a tensile tester (available from Orientech Co., Ltd.), and was pulled at a rate of 50 mm/min for conducting the 90-degree peeling test between the stainless steel plate 12 and the vibration damping rubber plate 11. As a result, a load at a breaking point (breaking force (N/cm)), a state of a rupture cross-section (broken state) was measured and evaluated. For the evaluation of the broken state in Table 1, “R100” means that the rubber part was broken at 100%, and as its value comes to 0, the broken state of the rubber part comes to 0%. Further, “M” means the rupture between the undercoating adhesive layer and the stainless steel plate 12.

TABLE 1

| | | | | | Filling-liquid resistance | | | |
|---|---|---|---|---|---|---|---|---|
| | | | | | 100° C. × 500 Hr | | 120° C. × 500 Hr | |
| | Under | Finish | | | Breaking | | Breaking | |
| | Coating | Coating | Unvulcanized | | Force | Broken | Force | Broken |
| | Adhesive | Adhesive | Rubber | Toxicity | (N/cm) | State | (N/cm) | State |
| Example 1 | (i) | (i) | (i) | Non-toxic | 59.0 | R100 | 31.5 | R65/M35 |
| Example 2 | (i) | (ii) | (ii) | Non-toxic | 31.5 | R100 | 27.5 | R100 |
| Example 3 | (i) | (ii) | (iii) | Non-toxic | 39.3 | R100 | 35.4 | R100 |
| Comparative | (ii) | (i) | (i) | Toxic | 39.3 | R95/M5 | 3.9 | R20/M80 |
| Example 1 | | | | | | | | |

As can be understood from the results shown in Table 1, the specimens of Examples 1 to 3 were nontoxic and superior to that of Comparative Example 1 in filling-liquid resistance (especially, in the evaluation after soaking in ethylene glycol solution at 120° C. for 500 hours). Further, the same results as in Examples were obtained in the cases where XPJ-77 and XPJ-106 available from Lord Far East Incorporated were used instead of the undercoating adhesive (i).

### EXAMPLE 4 AND COMPARATIVE EXAMPLE 2

In order to validate the method of producing the vibration damping rubber member according to the second gist of the present invention, undercoating adhesive, finish coating adhesive and rubber composition were prepared as follows.

Undercoating Adhesive (I)

The undercoating adhesive (I) was prepared by mixing 20% by weight (just abbreviated to %, hereinafter) of xylene, 4.6% of ethyl benzene, 1.9% of hexamethylenetetramine, 2% of resorcinol, 56% of methyl isobutyl ketone, 1.5% of carbon black, 6% of zinc oxide, 5% of titanium oxide and 3% of butadiene resin.

Finish Coating Adhesive (I)

CSM adhesive excluding a tackifier (XJ-405 available from Lord Far East Incorporated)

Finish Coating Adhesive (II)

Chlorinated polyethylene adhesive (XJ-370 available from Lord Far East Incorporated)

Rubber Composition

Rubber composition (unvulcanized rubber) was prepared by kneading 100 parts of natural rubber, 35 parts of HAF (High Abrasion Furnace) carbon black (SEAST 3 available from Tokai Carbon Co., Ltd.), 5 parts of zinc oxide (one kind of zinc oxide available from Sakai Chemical Industry Co., Ltd.), 2 parts of stearic acid (LUNAC S-30 available from Kao Corporation), 0.7 parts of vulcanization accelerator (SOXINOL CZ available from Sumitomo Chemical Co., Ltd.) and 2 parts of sulfur (SULFAX 200S available from Tsurumi Kagaku Kogyo Kabushikikaisha) by means of a kneader and a mixing mill.

Each specimen was produced by using materials prepared in the above-mentioned manner in accordance with the embodiment shown in FIG. 5. First of all, metallic structures 21 each onto which an adhesive layer 22 was formed by spraying were installed in a mold assembly 23 composed of mold components 23a, 23b, 23c, 23d and 23e, as shown in FIG. 5. In detail, the adhesive layer 22 had a two-layered structure composed of an undercoating adhesive layer (thickness: 10 μm) formed by spraying an undercoating adhesive (I) and a finish coating adhesive layer (thickness: 10 μm) by spraying a finish coating adhesive (I) for Example 4 and a finish coating adhesive (II) for Comparative Example 2. Then, the mold assembly 23 was pressed (in each direction of arrows shown in FIG. 5) by three different ways of 39200N, 78400N and 117600N and the rubber composition prepared in the above-mentioned manner was injected into the molding space 24 defined by each surface of adhesive layers 22 formed on the metallic structures 21 and the mold assembly 23. Successively, the rubber composition was heated for vulcanization (at 150° C. for 20 minutes), and the resulting rubber material (vibration damping rubber) obtained by the above-mentioned vulcanization was removed with simultaneously releasing the press of the mold assembly 23.

At that time, occurrence of cohesive failure on a contact point 22A between the adhesive layer 22 and the mold component 23d was evaluated in Example 4 and Comparative Example 2 by visually observing smear of adhesive on a side of the mold compartment 23d. When such smear was not observed at all, the evaluation was excellent (∘). When such smear was slightly observed to the degree not to impart bad effects on quality, the evaluation was fair (Δ). When such smear was remarkably observed and the mold component was contaminated, the evaluation was bad (X). The results are shown in the following Table 2. Further, each specimen was prepared for the above-mentioned evaluation in two different ways that the contact area between the adhesive layer 22 and the mold compartment 23d was 1500 mm² or 625 mm².

TABLE 2

| | Contact Area | Press (N) | | |
|---|---|---|---|---|
| | (mm²) | 39200 | 78400 | 117600 |
| Example 4 | 1500 | ◯ | ◯ | ◯ |
| | 625 | ◯ | ◯ | Δ |
| Comparative | 1500 | ◯ | ◯ | X |
| Example 2 | 625 | ◯ | X | X |

As is apparent from the above results, high-quality vibration damping rubber member can be produced with excellent mold processability and mass productivity in the Example 4 since the specimen could be removed from the mold assembly without mold smear regardless of the pressing strength and the contact area of the mold assembly 23. On the other hand, the mold smear was remarkably observed in the Comparative Example 2, especially when the pressing strength was high.

What is claimed is:

1. A vibration damping rubber member comprising a metallic structure and a rubber material, which are interposed by an undercoating adhesive layer formed on the metallic structure and a finish coating adhesive layer formed on the undercoating adhesive layer and are integrally formed via the adhesive layers, wherein the undercoating adhesive layer is formed by resorcinol adhesive (component (A)), the finish coating adhesive layer is formed by adhesive consisting mainly of chlorinated polyolefin (component (B)), and the rubber material is bonded onto the finish coating adhesive layer by vulcanization.

2. A vibration damping rubber member according to claim 1, wherein the component (A) is resorcinol adhesive excluding selenium.

3. A vibration damping rubber member according to claim 1, wherein the component (A) comprises butadiene resin (component (a)), hexamethylenetetramine (component (b)) and resorcinol (component (c)) as a resin component and the component (A) contains the component (c) at a rate of 1 to 25 parts by weight based on 100 parts by weight of solid content of the component (A).

4. A vibration damping rubber member according to claim 3, wherein the component (A) further comprises zinc oxide (component (d)) and titanium oxide (component (e)) in addition to the components (a) to (c) and the component (A) contains the component (d) at a rate of 20 to 50 parts by weight and component (e) at a rate of 20 to 50 parts by weight, respectively, based on 100 parts by weight of solid content of the component (A).

5. A vibration damping rubber member according to claim 1, wherein the component (B) is at least one of chlorosulfonated polyethylene (CSM) and chlorinated polyethylene.

6. A vibration damping rubber member according to claim 1, wherein the component (B) excludes chlorinated natural rubber.

7. A vibration damping rubber member according to claim 1, wherein the rubber material is formed into a chamber wall to be deformed according to a vibrational input and liquid is filled into an enclosed space defined by the chamber wall and a part of the metallic structure.

8. A method of producing a vibration damping rubber member of a metallic structure and a rubber material integrally formed therebetween via two adhesive layers by press molding, the method comprising the steps of forming an undercoating adhesive layer by resorcinol adhesive (component (A)) on an interface of the metallic structure, forming a finish coating adhesive layer on a surface of the undercoating adhesive layer by chlorosulfonated polyethylene (CSM) adhesive excluding a tackifier (component (B′)), preparing a mold assembly having a cavity, pressing a rim of the cavity onto a surface of the metallic structure via the two adhesive layers, injecting a rubber composition into a molding space defined with the surface of the two adhesive layers and the cavity, vulcanizing the rubber composition, and removing the metallic structure provided with the rubber material formed by vulcanization simultaneously when releasing the press.

9. A method according to claim 8, wherein the component (B′) excludes a tackifier selected from the group consisting of rosin, rosin derivative, polyterpene resin, terpene phenol resin and petroleum resin.

10. A method according to claim 8, wherein the component (B′) excludes chlorinated polyethylene and chlorinated natural rubber.
